(19) United States
(12) Patent Application Publication
(10) Pub. No.: US 2021/0371307 A1
(43) Pub. Date: Dec. 2, 2021

(54) METHOD AND ARRANGEMENT FOR TREATING WATER IN A POOL

(71) Applicant: SAFE WATER SCANDINAVIA AB, Kungsbacka (SE)

(72) Inventors: Sven BOETHIUS, Nice (FR); Björn WICKMAN, Floda (SE); Anders HELLMAN, Stenungsund (SE); Andreas DARNELL, Varberg (SE)

(21) Appl. No.: 17/288,312

(22) PCT Filed: Oct. 25, 2019
(86) PCT No.: PCT/SE2019/051052

§ 371 Date: Apr. 23, 2021

(30) Foreign Application Priority Data
Oct. 26, 2018 (SE) 1851328-3

(51) Int. Cl. C02F 1/467; C02F 1/461

(52) U.S. Cl. CPC C02F 1/4674; C02F 2101/16; C02F 1/46104

(57) ABSTRACT

Disclosed is a method and a system for cleaning water in pools, particularly reducing undesired disinfection-by-products. An electrolytic system includes an electrode arrangement including first and second electrodes, functioning as an anode and a cathode, and an Electronic Control Unit. The ECU controls the process so the potential of the anode is 1.4-2.3 V, more preferably 1.6-2.1 V and most preferably 1.7-1.9 V relative the Reversible Hydrogen Electrode. The system and method may further include the use of a reference electrode to control the potential of the first or second electrode to function as a working electrode and being the anode relative the other one of the first and second electrodes being the cathode and functioning as a counter electrode. The ECU could be programmed to alternately control the first electrode 101 and the second electrode to function as anode and cathode

### TECHNICAL FIELD

The present invention relates to a method and a system for cleaning water in pools and in particular in indoor pools. The invention is in particular directed to reducing the amount of undesired disinfection-by-products (DBP), which may be harmful to inhale, e.g. chlorinated substances such as trichloramine.

### BACKGROUND

Swimming pool water will receive a variety of organic materials from swimmers, such as urea (from urine, sweat and skin), hair, and cosmetics. Urea is one of the most abundant contaminants in pool water. The growth of microbiological infectants such as bacteria, virus, and fungi are promoted by the presence of organic nutrients and pose serious hazards to swimmers' health. Their infecting capability is dependent on pathogen's ability to pass the cell wall of microorganisms, which is then determined by surface charge and extent of hydration. Diseases like cholera, fever, gastroenteritis and schistosomiasis can develop by drinking infectious water. These contagious agents are eliminated through disinfection. Typical disinfecting methods include the usage of chlorine, hypochlorite, chlorine dioxide, bromine, ozone, ultraviolet (UV) light and electrochemical approaches. Electrochemical treatment of water is for example disclosed in US 2017/218 529, AU 1994/64 807 and GB 2,368,838. Despite choices of several methods, disinfection by chlorine still remains the most common choice in swimming pools. The major oxidizing mechanism of free chlorine (OCI—) is believed to be chlorine substitution into proteins and nucleic acids of cells. Destroyed infectants are turned into inactivated forms. For example, formation of intracellular metabolites may be released into air by chlorination of algae in the swimming pools.

In addition, regular monitoring and feeding of free chlorine is essential for keeping the desirable disinfecting capacity. In swimming pools, the free chlorine is maintained at certain level (usually 0.5-1.5 mg/L) so that it can achieve the desired disinfection effect. The need for continuous feeding is because the stability of free chlorine solution is not infinite, but strongly dependent on concentration, temperature, pH, impurities, UV light, water circulation, and also the number of swimmers.

Even though harmful bacteria and other infectants are made harmless by disinfection chemicals, there are usually disinfection-by-products (DBP) left. There is a growing concern regarding health risks caused by these DBPs, which exist in most chlorine treated water. The type of by-products formed are determined by the disinfection conditions, including pH, temperature, types of infectants in the swimming pool, type of reactions, chemical concentration and disinfection methods, and so forth. For chlorination, i.e. disinfection with chlorine, hypochlorite, or monochloramine, the DBPs are trihalomethanes, haloacetic acids, chloramines, haloacetonitriles, chloral hydrate, chlorate, aldehydes and many more. The sum of chloramines (NH2Cl, NHCl2, and NCl3) is known as combined chlorine and the sum of combined chlorine and free chlorine is total chlorine.

DBPs generally exist in a relatively small amount as to original infectants concentration, but their health risks cannot be ignored. One of the most harmful and well-studied compound is trichloramine, or the so-called nitrogen trichloride. It is formed from reaction between chlorine and amine-related compounds, including ammonia and urea. Typical concentration of trichloramine in water is very low because of its low solubility in water and high volatility. However, it accounts for the most abundant DBP in the surrounding air. Good ventilation of indoor pools can effectively decrease concentration of trichloramine in the air. Outdoor swimming pools usually have fewer problems with trichloramine thanks to the open air environment. However, even if there is well-functioning ventilation in the case of an indoor pool or if the pool is an outdoor pool, the concentration of trichloramines could still be quite high close to the surface of the pool and thus be a problem for swimmers breathing and inhaling the air close to the pool surface.

Health risks and syndromes that have been linked to DBPs, such as cytotoxicidity, cancer, asthma, coughing, itchy eyes, red eyes, runny nose, voice loss, cold, diarrhea, skin inflammation/rash (contact dermatitis), atopy, rhinitis, upper respiratory syndromes and other airway inflammation. These syndromes happen especially often on children, frequent swimmers and indoor swimming pool attendants. While trihalomethanes are the most abundant DBP in pool water, they are not a significant cause of all these diseases, unless at very high concentration. Trihalomethanes are easily metabolized by the liver in humans and thus pose much less treat. Haloacetic acids are also rapidly metabolized or excreted. Other less abundant DBPs have taken up fewer concerns and have not been fully studied in literature. Trichloramine is regarded as one of the major causes for most diseases.

It is therefore a desire for an improved method and system for keeping a pool in a clean and sanitary condition and reducing the amounts of undesired disinfection-by-products (DBP) arising from the use of chlorine.

### DISCLOSURE OF THE INVENTION

The object of the invention is to reduce the amounts of undesired disinfection-by-products (DBP) arising from the use of chlorine. In particular the invention is directed to reduce the amounts of trichloramine.

This object is achieved by a method according to claim 1 and a system according to claim 9.

The method according to the invention comprises the following step of subjecting the pool water to an electrolytic treatment. A purpose of the electrolytic treatment is to reduce the amount of chloramines and in particular trichloramines. In general, water from the pool is circulated through a purification circuit. The basic idea is to provide the purification circuit with an arrangement for electrolysis comprising a first electrode zo and a second electrode connected to a power supply and functioning as anode and cathode. The power supply is controlled by an Electronic Control Unit (ECU). Electrolysis is the use of direct electrical current to generate continuous electrochemical reactions in the electrolyte. Electrolysis can be used to drive a non-spontaneous reaction and to modify the composition/amount of e.g. DBP in the solution. The electrolytic process can be controlled by regulating the voltage or current to a desired value. Through research and tests it has been observed that an electrolytic process having a potential of the anode within the range of 1.4 V to 2.3 V is able to reduce the amount of chloramines, in particular trichloramines, in the water. A potential within the range of 1.6 V to 2.1 V is more preferred and most preferably within the range of 1.7 V to 1.9 V. The potential of the anode is in this case defined in relation to the Reversible Hydrogen Electrode (RHE) which is a reference electrode. The RHE is a subtype of the Standard Hydrogen Electrode (SHE) used for electrochemical processes. In practice, other kind of reference electrodes may be used and calibrated relative to RHE in order to achieve the desired potential of the anode. In general, it is preferred to use a reference electrode in the electrode arrangement used to treat the water but the arrangement may also work without a reference electrode, e.g. by pre-calibrating the electrode arrangement before installation in the pool to be treated. In those cases when there is a reference electrode present, the one of the first or second electrode which is controlled to a desired potential relative the reference electrode is generally referred to as the working electrode and the other one of the first or second electrode is referred to as counter electrode.

By subjecting the water to an electrolytic treatment within the potential ranges mentioned above, the concentration of trichloramines is reduced due to dissociation of trichloramines and/or prevention of the formation of trichloramines. In addition, the electrolytic treatment will also in part produce free chlorine, which is desired for its disinfecting properties, and the amount of chlorine to be added to the pool water is thus reduced since chlorine is regained in the process.

Electrolytic processes are often controlled by controlling the current to a desired value. In this case, the electrolytic process is preferably controlled by regulating the potential of an electrode to be at a desired value. By regulating the potential, good zo selectivity may be achieved and undesired side reactions may be avoided such as the dissociation of water into oxygen and hydrogen which may be a danger if the voltage not is controlled. In addition, if the potential is too low or too high, the electrolytic process will not work as desired in order to reduce the amount of trichloramines.

As discussed above, the electrolytic process may be controlled without the use of a reference electrode. However, it is in many cases the easiest and most reliable way to control the potential of the electrode by using a reference electrode. A reference electrode is an electrode having a constant redox potential at equilibrium. In a simple two-electrode setup, comprising a first electrode and a second electrode arranged to function as anode and cathode, a voltage between anode and cathode may be measured, but the actual potential on the anode is unknown unless there is a reliable reference used. In systems where parameters are known concerning the electrolyte and the electrodes, and the system is stable, a potential may be estimated from pre-calibrations and/or measuring relevant parameters of the electrodes and the electrolyte in which the electrolytic process is performed. However, in order to easily provide a reliable potential at the first or second electrode, a reference electrode may be used to provide a three-electrode configuration wherein one of the first or second electrodes is controlled to a specific potential and thus is functioning as a working electrode while the other electrode is functioning as a counter electrode. The reference electrode serves as a stable reference of potential so that accurate control of potential on the working electrode can be achieved.

It has been stated above that the Reversible Hydrogen Electrode (RHE) is used as the reference for the potential in this process. However, if a reference electrode is used in the electrolytic arrangement, it may be any suitable reference electrode. The control of the electrolysis will thus be calibrated and adjusted for the potential difference between the RHE and the reference electrode used such that the potential relative the RHE will be within the intervals described above.

In order to achieve a desired treatment of the water and to sufficiently reduce the amount of chloramines, and in particular trichloramine, the surface area of the electrodes should be sufficiently large to provide a desired decrease in the concentration of chloramines. The combined surface area of the first and second electrodes should therefore in general be at least 0.0001 square meters per cubic meter of water in the pool to be treated, preferably at least 0.0002 square meters per cubic meter of water in the pool. Another way of defining the desired surface area could be to define that the combined surface area of the first and second electrodes is in general at least 0.002 square meters per cubic meter of water passing the electrodes every hour, preferably at least 0.003 square meters per cubic meter of water passing the electrodes every hour. The combined surface area of the first and second electrodes relative the flow of pool water in the purification loop could also be defined to be in general at least 0.0005 square meters per cubic meter of water passing through the purification conduit every hour, preferably an area of 0.001 square meter per cubic meter of water passing through the purification conduit every hour. The purification arrangement could be designed such that only a portion of this flow is directed to pass the electrode arrangement. The combined surface area of the electrodes relative the amount of water to be treated may be different depending on several parameters such as what kind of electrodes that are used, the amount of disinfection-by-products (DBP) in the water which in general is dependent on how many people that are using the pool as well as to which level the concentration of trichloramine is desired to be reduced. Hence, there may be occasions in which a rather small total surface area of the electrodes is needed relative the amount of water while in other circumstances a considerably larger total surface area is desired or needed and in certain cases it may be enough with less surface area of the electrodes than indicated above.

It shall be noted that there may be a number of first electrodes and second electrodes such that the total area of the first electrode and the second electrode may comprise a number of units or electrode packages which may be located at the same location or spread out at different locations. It may for example be possible to have 2 or more parallel unities providing for treatment by electrode packages provided in different purification circuits or parallel flows of the same purification circuit.

In order to keep the first and second electrodes clean and make the system work efficiently, the first electrode and the second electrode could be designed to alternately function as anode and cathode by switching the polarity.

The system is controlled by an electronic control unit (ECU). The control unit controls the potential to be in the desired range. The control unit can also be designed to alternately use the first and second electrodes to be used as anode and cathode. The control unit may further be connected to a reference electrode and use the input from the reference electrode to a more accurate control of the voltage. In addition, the control unit may be connected to further sensors for input such as sensors for measuring the amount or concentrations of relevant substances in the water, e.g. the amount of free and combined chlorine, the redox potential and pH-measure, as well as sensors for the temperature of the water and flow through the electrolytic system. In particular, concentrations of relevant substances may be measured upstream and downstream of the electrolytic system in order to get relevant information concerning the efficiency in decreasing the amount of chloramines. A low efficiency could be an indication of a need to clean the electrodes, adjusting the potential of the anode (working electrode) or finding other disturbances in the system which should be adjusted.

The system may further be provided with additional equipment such as sensors and further control programs in order to control the system to be used in a proper way and not using the system at full capacity when not needed. For example, the one or several sensors may be designed to measure relevant parameters for estimating the amount of combined chlorine in the pool water. If the amount of combined chlorine is below a certain limit, the system may be controlled to be shut down or run at a fraction of the full capacity of the system. In case there are provided several electrolysis cells forming part of the electrolytic system, the reduced capacity demand may render one or several of the electrolysis cells to be shut off while one or several other electrolysis cells are working at full capacity. Alternatively, all the electrolysis cells are turned off and switched on at the same time so that there will be a mean time value corresponding to a desired total working cycle. Hence, if half the effect is desired the system may be controlled to switch off half of the cells (corresponding to half of the full capacity) or using an intermittent purification cycle in which the full capacity is used for a certain time period, e.g. one hour, where after the complete electrolytic system including all electrolysis cells are switched off for a suitable time period.

It shall be noted the electrolytic purification system may be used together with existing purification systems and equipment. If such systems already exists, relevant data may be used from the existing systems, e.g. sensed or measured data concerning combined chlorine, redox potential, pH or other relevant parameters, which may be used also for the control of the electrolytic purification system disclosed herein. However, the electrolytic system needs not to be combined with another system in order to function. In general, this electrolytic system is in particular designed to be used for a pool using chlorine for disinfection.

### BRIEF DESCRIPTION OF THE DRAWINGS

The present invention will now be described more in detail with reference to the appended drawings, where:

FIG. 1 discloses electrode arrangements according to the invention

FIG. 2 discloses purification circuits for pool water comprising an electrode arrangement according to the invention

### DETAILED DESCRIPTION

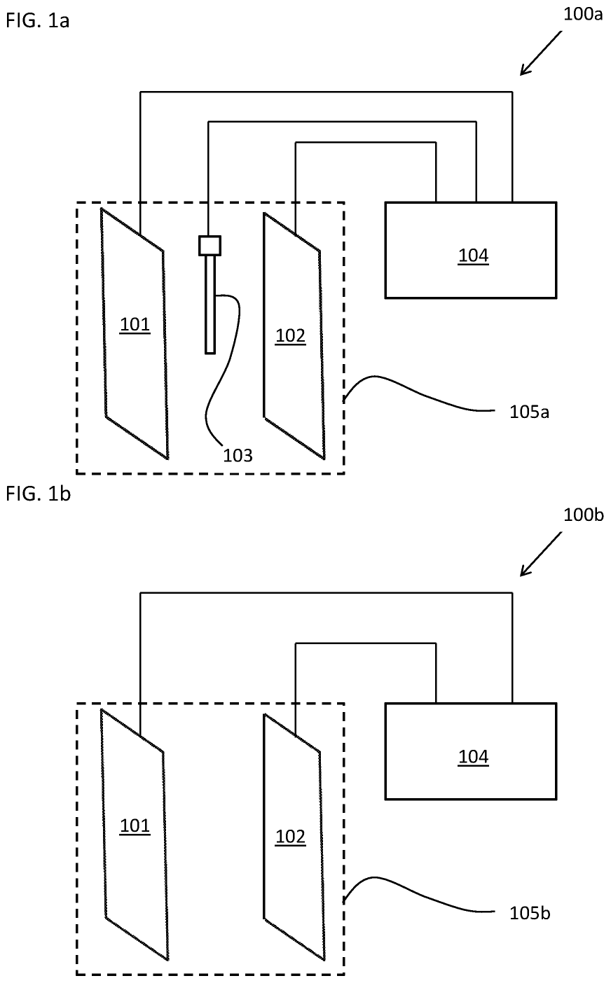

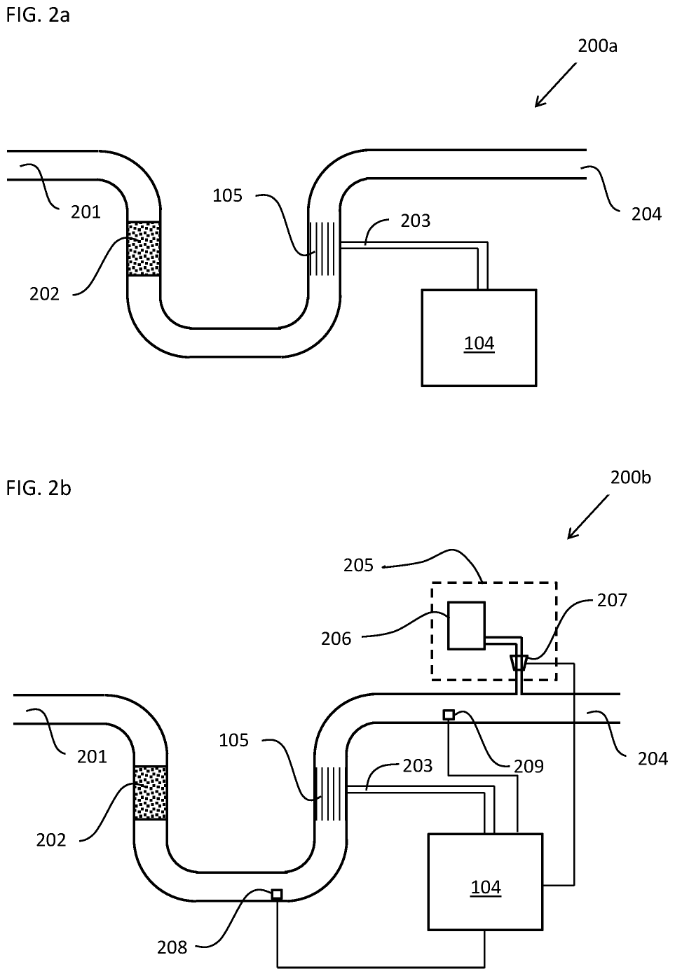

In FIG. 1a is disclosed an electrode arrangement 100a to be used for performing an electrolytic treatment of water in a pool. In general, the electrode arrangement 100a is located in a purification circuit into which pool water is taken from the pool. A purification circuit will be described below in FIGS. 2a and 2b. The electrode arrangement 100a comprises an electrode package 105a, also commonly referred to as an electrolysis cell, and an Electronic Control Unit (ECU) 104. The electrode package 105a comprises first electrode 101, a second electrode 102 and a reference electrode 103. The ECU 104 may be a single computational entity or comprising several different entities which together form the ECU 104. The ECU 104 is connected to the first electrode 101, the second electrode 102 and the reference electrode 103. However, the arrangement could be designed such that only one of the first electrode 101 or the second electrode 102 is connected to the ECU 104. The control unit 104 is programmed to control the electrical power which is delivered to the first electrode 101 or the second electrode 102 which thus will function as a working electrode and being controlled in dependence of the reference electrode 103. The other one of the first electrode 101 and the second electrode 102 will function as a counter electrode. The ECU 104 may be programmed to alternate between the first electrode 101 and the second electrode 101 to be used as the working electrode. The ECU 104 is thus designed to control the output voltage from an electric source to either or both of the electrodes 101, 102. The control output may be based on different electrical parameters such as the effect, voltage, potential or current. The ECU 104 could be connected to a multitude of sensors in order to control the process according to relevant parameters. This will be further discussed with reference to FIG. 2b. In the arrangement in FIG. 1a, where a reference electrode 103 is present, it is in general indicating a desire to control the working electrode to a desired potential relative the reference electrode. For the specific purpose which the electrode arrangement 100a is intended to be used, the potential of the working electrode is important in order to function as desired why the ECU 104 preferably is programmed to control the working electrode to a desired potential or range of potentials.

It is described that it is possible to only connect one of the electrodes, e.g. the first electrode 101, to the ECU 104 to be used as the working electrode. However, it may be useful to connect both the first electrode 101 and second electrode 102 to the ECU such that both the first and second electrodes 101, 102 may be controlled by the ECU 4 and the ECU may control the electrodes 101, 102 to switch between using the first electrode 101 and the second electrode 102 as working electrode. By switching the electrode to be used as working electrode the deterioration of the working electrode may be reduced and the equipment will endure and function satisfactorily for a longer time.

The electrode arrangement 100a is disclosed in a schematic and simplistic way in FIG. 1. The ECU 104 is connected to the electrodes 101, 102 in order to provide a desired voltage to either of them to function as the working electrode while receiving input from the reference electrode 103 in order to calibrate the power supply such that the potential is controlled to a desired potential, e.g. 1.8 V, or to be within a desired range, e.g. 1.5 to 2.3 V, relative the Relative Hydrogen Electrode (RHE). Hence, in this case, the working electrode will thus be used as an anode. To be noted, the reference electrode 103 need not to be the RHE but may be another reference electrode which has been calibrated in relation to the RHE such that a potential relative the RHE may be computed by the ECU 104 knowing the internal relations between the reference electrode 103 used and the RHE.

In more advanced configurations, the ECU 104 may be connected to further devices, e.g. sensors for sensing the pH in the water to be treated, amount of chlorine/chloramines in the water, temperature or other kind of sensors which may be used as input in order to control the power supply to the electrodes.

In FIG. 1b is disclosed an alternative embodiment in which the electrode arrangement 100b comprises an electrode package 105b which comprises the first electrode 101 and the second electrode 102 but not a reference electrode. The electrode arrangement 105b could for example be pre-calibrated and controlled to provide the desired voltage for certain conditions. In addition, in order to adapt the electrode arrangement, the ECU 104 could be connected to further sensors for sensing relevant conditions of the water. It could also be possible to use some kind of look up table or diagrams where a relevant output to the first electrode 101 or second electrode 102 is estimated based on the usage of the pool to be cleaned, e.g. by counting the number of people entering the pool area and thus adapt the output from the ECU 104 to meet the expected demand depending on the amount of users.

Hence, an electrode package 105b as described in FIG. 1b may function and provide for purification of a pool even though a more efficient control to the desired potential is generally achieved by using an electrode package 105a as described in FIG. 1a where a reference electrode 103 is present and may be used to calibrate the electrode being used as an anode to the desired potential.

The electrode arrangements 100a, 100b in FIGS. 1a and 1b only serves as examples of how an electrode package may be configured. The electrode packages 105a, 105b may be modified and a single electrode package may include several first and second electrodes 101, 102. There may also be several electrode packages connected to the ECU 104 and a single reference electrode 103 may be used to serve as a reference electrode for a multitude of electrode packages. It shall further be noted even when a reference electrode is present, it need not be located adjacent to the first and second electrodes but could be located at another location in the purification loop or in the pool, e.g. at the inlet to a purification circuit.

In FIG. 2a is disclosed a purification circuit 200a including an electrode package 105 as for example disclosed in FIG. 1 or FIG. 2. The electrode package 105 thus comprises the first electrode 101, the second electrode 102 and possibly a reference electrode 103 as disclosed in FIG. 1a. The electrode package 105 is connected to the ECU 104. The purification circuit 200a is provided with an inlet side 201 to which zo water from a pool enter the purification circuit 200. The pool water entering the purification circuit 200 is directed to a filter 202 located upstream of the electrode package 105. In general it is desired to have the filter 202, e.g. a sand filter or other kind of filter for filtering particulate matter, upstream of the electrode package 105 in order to reduce particulate matter entering into the electrode package 105. The electrode package 105 is configured such that the flow of pool water will pass and be in contact with the first electrode 101, the second electrode 102 and, if present, the reference electrode 103 (se FIGS. 1a and 1b). The first and second electrodes 101,102 functioning as anode and cathode should be arranged relative each other such that they are rather close to each other in order to reduce the effect needed to create a current and provide for an efficient purification while at the same time being spaced apart sufficiently in order to allow a flow of water to flow smoothly over the surfaces of the electrodes 101, 102 such that stationary zones are avoided. Hence, the specific configuration may depend on the flow rate the electrode arrangement 105 is designed for. The electrode package 105 is connected to the ECU 104 via cables 203. The water passing through the electrode package 203 is guided further to an outlet side 204 in order return to the pool.

In FIG. 2b is an alternative embodiment of a purification circuit 200b disclosed. In this purification circuit 200b has further features been added which are commonly occurring in purification circuits. The purification circuit 200b comprises all the features included in the purification circuit in FIG. 2a but has been additionally provided with a chemical feeder 205 comprising a can 206 for storing chemicals and a dosage unit 207 which controls the adding of the chemicals from the can 206 via a feeder conduit. The dosage unit 207 is connected to the ECU 104 which controls output signals to the dosage unit 206 in order to regulate the amount of chemicals to be added to the pool water. The chemicals in the can 206 may for example be chlorine or chlorine containing compounds to be used for purification and disinfection of the pool water.

The purification circuit 200b in FIG. 2b further comprises a first sensor 208 located downstream of the filter 202 and upstream of the electrode package 105 in order to measure relevant parameters before the pool water passes through the electrode package 105. A second sensor 209 is located downstream the electrode package 105 but upstream of the conduit from the chemical feeder 205. This second sensor 209 may thus measure relevant parameters downstream of the electrode package 105 after the pool water has been subjected to the treatment in the electrode package 105. The sensors could for example be designed to measure the amount of trichloramines or some other parameter relevant for estimating the efficiency of the electrode package and detect if the treatment in the package is working as it should. The sensors are connected to the ECU 104 such that the input from the sensors 208, 209 may be used in the computing of the outputs from the ECU 104 and thus the control of the electrode package 105 and/or the chemical feeder 205.

The schematic drawings in FIGS. 1 and 2 only serve as some examples of how an arrangement according to the invention may be designed. For example, the filter 202 in FIGS. 2a and 2b is located upstream of the electrode package 105. However, the filter may be located downstream, or there may be one or several filter units arranged upstream and/or downstream, of the electrode package 105 or even work without any filter in the purification loop in which the electrode package 105 is located.

The electrode arrangement 100a, 100b may be used to retrofit into existing purification circuits or may be added as a separate purification unit in a separate circuit. The electrode arrangement may thus be used together with existing purification devices or as the only purification unit in the pool. However, since the electrode package 105 is intended to be used for reducing the amount of chloramines, in particular trichloramines, it is evident that it is mainly intended to be used in pools where chlorine is present, e.g. where chlorine is used as a disinfectant in pool water.

The electrodes to be used may be made of a variety of different materials and commercially available electrodes may be used. Generally, the first and second electrodes are made of the same material even though they may be made from different materials. In particular, when the first and second electrodes are alternately used as the working electrode by switching the polarity of the electrodes, they are suitably made of the same material.

### EXPERIMENTS

Apart from laboratory tests, experiments have been performed in two pilot tests performed on two different indoor pools. The equipment used basically corresponds to the electrode arrangement 100a disclosed in FIG. 1a with an electrode package 105a comprising a first electrode 101, a second electrode 102 and a reference electrode 103 which were connected to an ECU 104. The first and second electrodes 101, 102 were commercially available electrodes made of MMO material and the reference electrode used was an Ag/AgCl reference electrode of a type that is commercially available. The electrode package was fitted into an existing purification circuit in the respective pools. In order to fit the electrode package into the purification circuit, a portion of the water passing through the existing purification loop was redirected to a separate circuit passing the electrode package before the water was returned to the existing purification circuit. Hence, the equipment was placed in the water purification circuit for the swimming pools reminding of the arrangement is FIG. 2a where water from the existing purification circuit was entering at the inlet side 201 and passed the electrode package 105 before the pool water was returned to the existing purification circuit via the outlet side 204.

When measuring the efficiency of the electrode arrangement used in the pilot tests related to reduction of trichloramine leaving the pool water, baseline measures were made prior to the installation and similar measurements were made during the pilot period with the electrode arrangement in use.

The measuring procedure used the following steps:

(1) taking water samples out of the water purification circuit into a container, followed by

(2) extracting samples of the air inside the container

(3) measurements of the trichloramine concentration in the extracted samples were conducted.

With this method, the effect of the pool hall ventilation system was avoided.

Pilot test one was performed on a small swimming pool, 85 m3 in volume, with a water throughput in the purification circuit of 58 m3/hour, of which 20 m3/hour passed through the electrode arrangement, which had an electrode contact surface area (with the water passing) of 19 dm2 (for the first electrode and the second electrode combined).

The system was controlled to a potential of 1.8 V on the working electrode.

Compared with the baseline trichloramine concentration of 0.7 PPM, pilot test one showed a reduction of 60-70% of that count.

Pilot test two was performed on a larger swimming pool, 630 m3 in volume (25×16m), with a water throughput in the purification circuit of 100 m3/hour, of which 30 m3/hour passed the electrode arrangement. The combined electrode contact surface area was 38 dm2. The same potential control was used as in pilot one.

Compared with the baseline trichloramine concentration of 1.0 ppm, pilot test two showed a reduction of 65-70% of that count.

The two swimming pools used for these pilot tests were of a “better than average” standard regarding trichloramine counts made the standard (pool-side) way, before the introduction of the electrode arrangement.

The results of the pilots show a significant reduction of the trichloramine count and reduced the concentration of trichloramines in the pool water of up to 70%.

1. A method for reducing the concentration of trichloramines in pool water, comprising the step of subjecting the water to an electrolytic treatment by using a first electrode (101) and a second electrode (102) functioning as an anode and a cathode wherein the anode is controlled to have a potential of between 1.4 V and 2.3 V relative the Reversible Hydrogen Electrode (RHE).

2. The method for treatment of water according to claim 1, wherein the anode is controlled to have a potential of between 1.6 and 2.1 V relative the Reversible Hydrogen Electrode (RHE).

3. The method for treatment of water according to claim 2, wherein the anode is controlled to have a potential of between 1.7 and 1.9 relative the Reversible Hydrogen Electrode (RHE).

4. The method for treatment of water according to claim 1, wherein a reference electrode (103) is used in order to control the potential of the anode to a desired value.

5. The method for treatment of water according to claim 1, wherein a combined surface area of the first and second electrodes (101, 102) is at least 0.0001 square meters per cubic meter of water in the pool to be treated.

6. The method for treatment of water according to claim 1, wherein a combined surface area of the first and second electrodes (101, 102) is at least 0.0005 square meters per cubic meter of water passing through the purification conduit every hour.

7. The method for treatment of water according to claim 1, wherein a combined surface area of the first and second electrodes (101, 102) is at least 0.002 square meters per cubic meter of water passing the electrodes every hour.

8. The method for treatment of water according to claim 1, wherein the first electrode (101) and the second electrode (102) alternate between being used as the anode and the cathode.

9. The method for treatment of pool water according to claim 1, wherein the method either uses an external sensor system providing data input or comprises a sensor system for measuring relevant parameters in order to control electrolysis cells used for the electrolytic treatment.

10. An electrolytic system for reducing the concentration of trichloramines in pool water, said system comprising an electrode arrangement (100a, 100b) including a first electrode (101) and a second electrode (102) functioning as an anode and a cathode and an Electronic Control Unit, ECU, (104), wherein the ECU (104) is designed to control the process such that the potential of the anode is between 1.4 V and 2.3 V relative the Reversible Hydrogen Electrode (RHE).

11. The electrolytic system for cleaning water in pools according to claim 10, wherein the ECU (104) is programmed to alternately control the first electrode (101) and the second electrode (102) to function as anode respectively cathode.

12. The electrolytic system for cleaning water in pools according to claim 10, wherein the electrode arrangement (100a) comprises a reference electrode (103).

13. The method for treatment of water according to claim 1, wherein a combined surface area of the first and second electrodes (101, 102) is at least 0.001 square meters per cubic meter of water passing through a purification conduit every hour.

14. The method for treatment of water according to claim 1, wherein a combined surface area of the first and second electrodes (101, 102) is at least 0.003 square meters per cubic meter of water passing the electrodes every hour.

15. The method of claim 9, wherein the relevant parameters comprise parameters used for estimating the concentration of combined chlorine, redox potential or pH value in the pool water.

16. The electrolytic system of claim 10, wherein the ECU (104) is designed to control the process such that the potential of the anode is between 1.6 V and 2.1 V relative the Reversible Hydrogen Electrode (RHE).

17. The electrolytic system of claim 10, wherein the ECU (104) is designed to control the process such that the potential of the anode is between 1.7 V and 1.9 V relative the Reversible Hydrogen Electrode (RHE).

18. The method for treatment of water according to claim 2, wherein a reference electrode (103) is used in order to control the potential of the anode to a desired value.

19. The method for treatment of water according to claim 3, wherein a reference electrode (103) is used in order to control the potential of the anode to a desired value.

20. The method for treatment of water according to claim 2, wherein a combined surface area of the first and second electrodes (101, 102) is at least 0.0001 square meters per cubic meter of water in the pool to be treated.
